(19) United States
(12) Patent Application Publication
(10) Pub. No.: US 2008/0281760 A1
(43) Pub. Date: Nov. 13, 2008

(54) Service Negotiation

(75) Inventors: Joe H. Williams, Columbia, TN (US); Anthony Lee Hurt, Mt. Juliet, TN (US); William Lee Mitchell, Franklin, TN (US); Felix Orozco Ammay, Kings Mountain, NC (US); Aaron Harrell, Charlotte, NC (US)

Correspondence Address: THOMAS, KAYDEN, HORSTEMEYER & RISLEY, LLP/;AT&T Intellecutal Property I, L.P., 600 GALLERIA PARKWAY, S.E., SUITE 1500, ATLANTA, GA, 30339-5994, US

(73) Assignee: BellSouth Intellectual Property Corporation, Wilmington, DE (US)

(21) Appl. No.: 11/742,037

(22) Filed: Apr. 30, 2007

(51) Int. Cl. H04K 1/00

(52) U.S. Cl. 705/80

(57) ABSTRACT

Embodiments of a method for negotiating a service include enabling a first user to submit a set of information for establishing a service on behalf of another person, the set of information prohibited from being submitted by the first user unless the set of information completely satisfies criteria for the set of information that is needed for establishing the service in accordance with operating standards for establishing the service. The method further includes, after submission of the set of information by the first user, notifying a second user of the submission and enabling the second user to review the set of information and update the set of information with additional information regarding establishment of the service. Other methods and systems are also provided.

### TECHNICAL FIELD

The present disclosure is generally related to network communications and service negotiation.

### BACKGROUND

In setting up a service to a customer, a service consultant may have to communicate with other units within a business in order to establish the service, in addition to communicating with the customer. The task or role performed by one unit in establishing a service may not be able to commence until another unit has performed their task or role in establishing the service. Such communications are often made via e-mail and/or the printing of paper copies of requests to the respective unit. Further, if a service consultant does not obtain vital information from the customer that is needed by a technician to establish the service, then the technician is unable to set up the service based on information the technician receives from an e-mail from the service consultant. This creates unnecessary delay for everyone involved and increases the amount of work that has to be performed.

Thus, a heretofore unaddressed need exists in the industry to address the aforementioned deficiencies and inadequacies.

### SUMMARY

Embodiments of a method for negotiating a service include enabling a first user to submit a set of information for establishing a service on behalf of another person, the set of information not being able to be submitted by the first user unless the set of information completely satisfies criteria for the set of information that is needed for establishing the service in accordance with operating standards for establishing the service. Note, the first user may belong to a first unit that is responsible for part of establishment of the service. The method further includes, after submission of the set of information by the first user, notifying a second user of the submission and enabling the second user to review the set of information and update the set of information with additional information regarding establishment of the service. Note, the second user may belong to a second unit that is responsible for another part of establishment of the service, where the update of the set of information with additional information is not capable of being submitted unless the additional information satisfies criteria for the additional information that is needed for establishing the service in accordance with the operating standards for establishing the service. Such a method further includes, after submission of the additional set of information, notifying a user that is different than the second user of the submission of the additional set of information and enabling the user to review the information previously submitted by the first user and the second user.

Embodiments of the present disclosure also include a system for negotiating a service. The system includes a web server system facilitating a web-based forum enabling a first user to submit a set of information for establishing a service on behalf of another person. The set of information is not able to be submitted by the first user unless the set of information completely satisfies criteria for the set of information that is needed for establishing the service in accordance with operating standards for establishing the service which are enforced by the web server system. Note, the first user may belong to a first unit that is responsible for part of establishment of the service. After submission of the set of information by the first user, the web server system is configured to notify a second user of the submission and enable the second user to review the set of information and update the set of information with additional information regarding establishment of the service. Note, the second user may belong to a second unit that is responsible for another part of establishment of the service, where the update of the set of information with additional information is not capable of being submitted to the web server system unless the additional information satisfies criteria for the additional information that is needed for establishing the service in accordance with the operating standards which are enforced by the web server system. After submission of the additional set of information, the web server system is further configured to notify a user that is different than the second user of the submission of the additional set of information and enable the user to review the information previously submitted by the first user and the second user.

Other systems, methods, and/or computer program products according to embodiments will be or become apparent to one with skill in the art upon review of the following drawings and detailed description. It is intended that all such additional systems, methods, and/or computer program products be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an embodiment of a service negotiation system.

FIG. 2 is a block diagram of an embodiment of a client-server environment in which aspects of the system of FIG. 1 may be facilitated.

FIG. 3 is a block diagram of a computer system representing an exemplary server which may be utilized in the system of FIG. 1.

FIG. 4 is a block diagram illustrating an embodiment of an interactive service negotiation system from FIG. 1.

FIG. 5 is a flow chart illustrating an embodiment, among others, of functionality of the service negotiation system 100 of FIG. 1.

FIG. 6 is a diagram depicting an embodiment, among others, of a service fulfillment process in accordance with the present disclosure.

FIG. 7 is a diagram depicting an embodiment, among others, of a service fulfillment process in accordance with the present disclosure.

FIG. 8 is a flow chart of one embodiment, among others, of a process for negotiating a service in accordance with the present disclosure.

FIGS. 9-14 are screenshot diagrams of exemplary interfaces to an interactive service negotiation system from FIG. 1.

### DETAILED DESCRIPTION

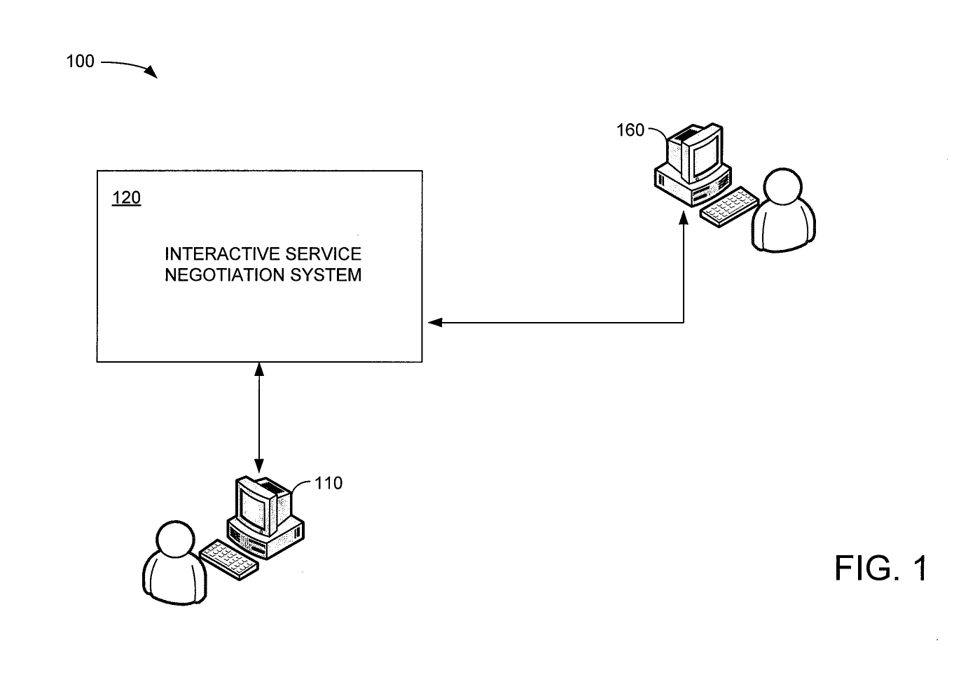

Referring to FIG. 1, one embodiment of a service negotiation system 100 is shown. According to an exemplary embodiment, the service negotiation system 100 provides automated communications between different business units for a seamless handoff of customer requests for service(s). While the description that follows is directed to a CrisisLink service request for a telecommunications provider for simplicity of explanation, it should be appreciated that exemplary embodiments may also be applicable to general service requests involving any type of service. Generally, a service may be regarded as work performed by a person or business for another person or customer at an agreed upon fee (hourly rate, flat fee, etc.). Often, in establishing a requested service, more than one business unit may be involved to establish the service.

In an exemplary implementation, a CrisisLink service allows customers to forward their calls to a back-up telephone number or numbers, in the event of an emergency. Therefore, if a telephone service associated with a telephone number becomes inoperable, telephone calls made to that telephone number may be forwarded to specified backup telephone numbers provided in the plan. Pursuant to this service, in the event of a service disruption, all communications directed to a particular previously selected directory number (or numbers) will be handled pursuant to a redirection scheme or plan preselected by the customer or subscriber.

One embodiment of the CrisisLink service for businesses can designate alternate routing of voice, data and video communications in the event normal business operations at the usual locations are interrupted. For example, if a major storm causes authorities to evacuate a community where a business is located, a pre-established CrisisLink plan would allow the business to reroute calls to another location. CrisisLink service can also give a business the capability to place test calls during or after a crisis to check the status of the business' regular service or location before returning it to normal operations. Further, the service can provide a customer with reports on the number of lines affected during a crisis, the number of calls rerouted and downtime experienced.

As an initial step in establishing the service, a customer contacts a service consultant about receiving the CrisisLink service or the service consultant contacts the customer to sell the customer the offered service. Next, the service consultant consults with the customer to determine which telephone numbers will be in the CrisisLink plan, what the back-up telephone numbers will be, the plan name, and other pertinent information.

Then the service consultant accesses a World Wide Web application called ISNS (Interactive Service Negotiation System) 120 (FIG. 1), and clicks on a link or button for inputting a new service. The service consultant inputs the information that is needed for the CrisisLink order, and clicks a SUBMIT button to submit the order for processing.

The ISNS 120 feeds information to and retrieves information from a CrisisLink database. Before submitting an order and inputting a new service request, the service consultant queries and makes sure that a CrisisLink plan or service does not already exist for a customer. The ISNS 120 does not allow the service request to be generated without a check for prior requests to be made, in some embodiments. Detecting a duplicative request at the onset reduces work and time delays.

Without such checks, information required by a network service center in order to do the provisioning of a requested service may not be complete and the network service center may not know where to get the missing information.

In one embodiment, among others, when a customer requests a modification to a pre-existing account or plan (e.g., adding additional back-up lines to alternate telephone numbers listed in plan, etc.), the customer's current information stored in the CrisisLink database is viewed. In performing the requested modification, a service consultant may surmise that some information is missing that is needed to complete the requested work. Therefore, by viewing the customer's actual information as they complete a new service request, the service consultant can determine if some of the current information appears inaccurate or if additional information is needed to perform the requested work.

If the CrisisLink plan or service does not already exist for a customer, the ISNS 120 allows for the service consultant to input information needed for making the service request and allows the service consultant to input the order. In attempting to input and submitting the order, if the ISNS 120 detects an error with the order, then the ISNS will inform the service consultant of the error with a message on the order form that has the error and allow the service consultant to correct the order. Additional checks may also be performed by ISNS 120 before the order can be submitted for provisioning as part of a service fulfillment process. The service fulfillment process may have stages as part of the process that have to be completed before other stages in the process can be performed. For example, information needed to input a service request has to be obtained before the service request can be attempted to be carried out, in one embodiment, among others. Accordingly, aspects of the service request may first require that one business unit performs a first function so that another business unit can perform a second function that is dependent upon the first function being completed. As one example, a service fulfillment process may include billing of services (that are handled by one business unit), but the services have to be performed (handled by one or more other business units) before billing can commence.

In one embodiment, among others, after an order is submitted successfully by the service consultant, another unit, the Advanced Intelligent Network Group (AING) at a network reliability center (NRC), picks up the NEW order via the ISNS 120 and places the order in a PROVISIONING state via the ISNS. ISNS 120 then sends an automated email back to the service consultant stating that the AING now has the order and has started provisioning the order. At the same or substantially the time, another automated email is sent to the network infrastructure support center (NISC) to have triggers added to the telephone numbers listed on the CrisisLink plan.

In some embodiments, the NISC adds a trigger to a switch where a redirected telephone number is associated. Therefore, when AING completes provisioning of the order and the plan is activated, rerouting of telephone numbers can occur in accordance with the requested service. In general, to keep the processing of data and calls as simple as possible, a relatively small set of triggers is defined at switches for each call. A trigger in an Advanced Intelligent Network (AIN) is an event associated with a particular subscriber line that generates a packet to be sent to an SCP (Service Control Point).

The trigger causes the SCP to query its database to determine which customized calling feature or enhanced service should be implemented for a particular call. The results of the database inquiry are sent back to the switch from SCP through an STP (signal transfer point). The return packet includes instructions to the switch as to how to process the call. The instruction may be to take some special action as a result of a customized calling service or enhanced feature. In response to receiving the latter type message, the switch moves through its call states, collects the called digits, and generates further packets that are used to set up and route the call. A regional STP and regional SCP provide similar devices for routing calls among various local exchange carriers.

In one embodiment, the service consultant preparing the order identifies that the NISC workgroup needs to add a trigger on a switch for a telephone number associated with the plan. The service consultant makes selections on the ISNS interface to indicate which NISC center in a multistate region is to be assigned to handling the work. After the selections have been, ISNS 120 automatically emails the appropriate NISC center and informs it of the work that needs to be done. After the NISC center completes the work, the NISC center makes selections on the ISNS to indicate that the work is completed for the requested service and then AING is notified of completion of the work by NISC. Accordingly, after AING completes their assigned work, AING makes selections on the ISNS 120 to indicate that their assigned work is completed and the service consultant is informed of the completion of the work by NISC. The service consultant may then contact the customer and inform the customer that the service is activated. Also, a billing unit may be informed and notified that a new service has been activated.

For example, a regional SCP and local SCP may be connected via respective data links to a service management system (SMS). The SMS also is implemented by a large general purpose computer and interfaces to business offices of the local exchange carrier and interexchange carriers.

The SMS downloads information to the databases of SCPs when subscribers set up or modify their ensemble of AIN services. Similarly, SMS downloads, on a non-realtime basis, billing information that is needed in order to appropriately invoice subscribers for the services provided. Therefore, an SMS may need to be configured to handle billing of a new service and such a task may be performed by a special business unit assigned to perform this function, among others.

Use of the service negotiation system 100 of the present disclosure helps streamline the service fulfillment process to the benefit of consumers and service providers, such as businesses.

Within one embodiment, among others, of the service negotiation system 100, a service consultant at a client device 110 accesses ISNS 120, as shown in FIG. 1. Via the ISNS 120, the service consultant may access a web interface to ISNS 120. The web interface allows for the service consultant to view information on the customer and to also input information regarding the customer or the customer's service request. The service consultant from the client device 110 may use the web interface of ISNS 120 to review a submitted service request or modify contents of a submitted service request. Also, other personnel responsible for handling an aspect of the service request may access the web interface via a client device 160 and may also update content of the service request.

ISNS 120 may enforce rules on what information has to be provided by a user inputting information before ISNS 120 will accept a new submission or update of information. For example, in preparing a service request order, a customer's name, plan name, charge numbers, passwords for the customer's account, etc. may be required to be supplied in the request. Further, ISNS 120 may enforce formatting rules. For example, a particular field may be required to have 10 digits or characters as input. If the field does not meet this requirement, the service request will not be accepted. As another example, for some fields in some embodiments, a desired date for completion of the work is to be inputted. A requirement may be programmed into the ISNS 120 that the desired date must be at least 7 working days from the current date. To facilitate this requirement, ISNS 120 may provide an input box to the user with all the available dates that satisfy the requirement such that the user can select one of these dates as the desired date for completion of the work.

Further, ISNS 120 may be programmed to work hand in hand with operating standards for a particular service fulfillment process. In this way, instead of waiting for email communications and verifying receipt of messages using read receipts to determine whether or not the right department received a request, each party involved in processing a service request can mark completion of their respective parts using interfaces of ISNS 120. When the respective part is marked as completed, ISNS 120 automatically notifies (e.g., via email) other respective parties that work has been completed. Further, when a party finds a problem in a request (e.g., a telephone number is not correctly specified), instead of having to call the service consultant or other party, the party can mark the activity or request as “troubled” on an interface of ISNS 120. For example, a user can write a note associated with the service request (as mentioned later) regarding the problem that has been encountered by the user. The user can submit these findings, and the ISNS 120 notifies the service consultant of the information supplied by the user. The service consultant can then possibly correct the information, update the status of the request, and the user may then be notified that the information has been corrected and he or she can continue with his or her work.

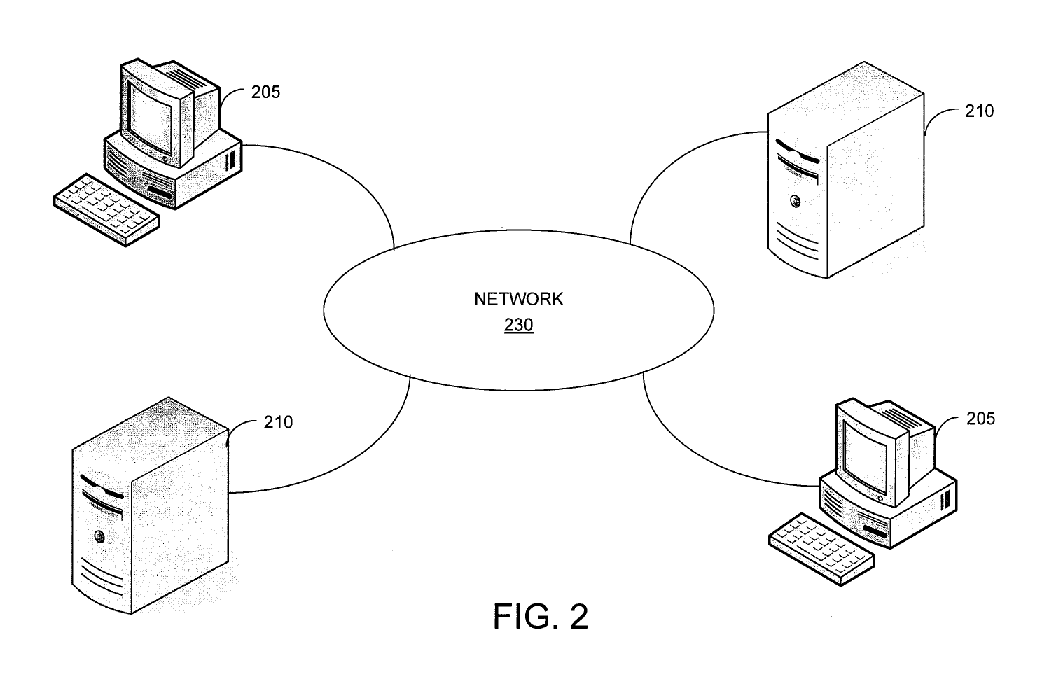

Next, FIG. 2 shows one embodiment, among others, of a client-server environment, such as the World Wide Web (the Web), in which the service negotiation system 100 may be facilitated. The architecture of the Web follows a client-server model. The terms “client” and “server” are used to refer to a computer's general role as a requester of data (the client) or provider of data (the server). Web clients 205 and Web servers 210 communicate using a protocol such as HyperText Transfer Protocol (HTTP). In the Web environment, Web browsers reside on clients 205 and render Web documents (pages) served by the Web servers 210. The client-server model is used to communicate information between clients 205 and servers 210. Web servers 210 are coupled to a network 230 (e.g., Internet) and respond to document requests and/or other queries from Web clients 205. When a user selects a document by submitting its Uniform Resource Locator (URL), a Web browser, such as Mozilla Firefox®, Netscape Navigator®, or Internet Explorer®, opens a connection to the server 210 and initiates a request (e.g., an HTTP get) for the document. The server 210 delivers the requested document, typically in the form of a text document coded in a standard markup language such as HyperText Markup Language (HTML).

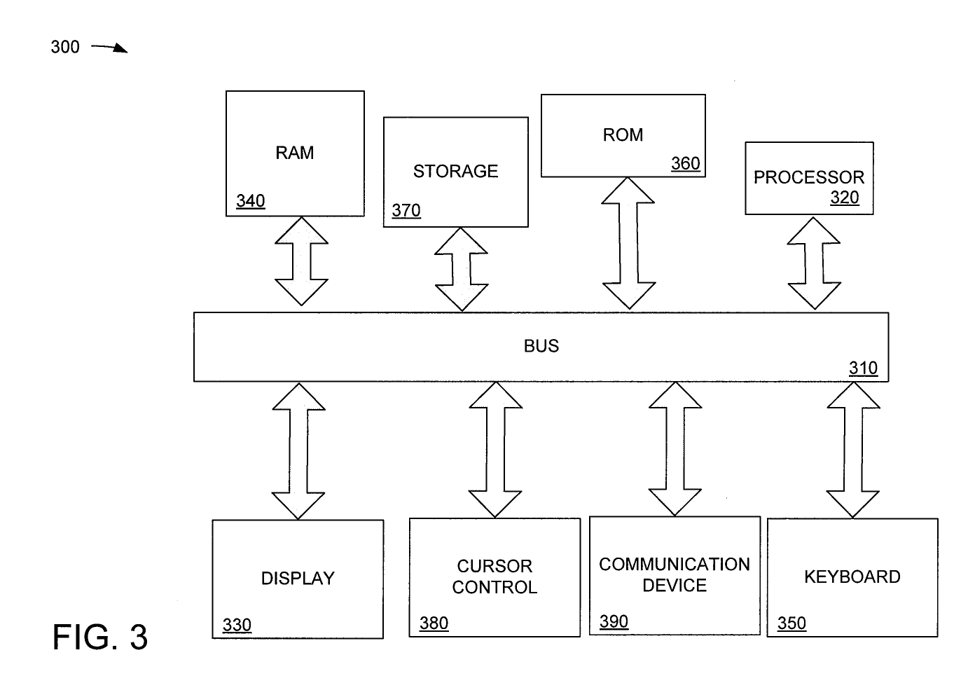

Accordingly, FIG. 3 is a computer system 300 representing an exemplary server which may be utilized in the system of FIG. 1. Computer system 300 comprises a bus or other communication means 310 for communicating information, and a processing means such as processor 320 coupled with bus 310 for processing information. Computer system 300 further comprises a random access memory (RAM) or other dynamic storage device 340 (referred to as main memory), coupled to bus 310 for storing information and instructions to be executed by processor 320. Main memory 340 also may be used for storing temporary variables or other intermediate information during execution of instructions by processor 320. Computer system 300 also comprises a read only memory (ROM) and/or other static storage device 360 coupled to bus 310 for storing static information and instructions for processor 320.

A data storage device 370 such as a magnetic disk or optical disc and its corresponding drive may also be coupled to computer system 300 for storing information and instructions. Computer system 300 can also be coupled via bus 310 to a display device 330, such as a cathode ray tube (CRT) or Liquid Crystal Display (LCD), for displaying information to a computer user. Typically, an alphanumeric input device 350 (e.g., a keyboard), including alphanumeric and other keys, may be coupled to bus 310 for communicating information and/or command selections to processor 320. Another type of user input device is cursor control 380, such as a mouse, a trackball, or cursor direction keys for communicating direction information and command selections to processor 320 and for controlling cursor movement on display 330.

A communication device 390 is also coupled to bus 310 for accessing remote servers via a network, such as the Internet, for example. The communication device 390 may include a modem, a network interface card, or other commercially available network interface devices, such as those used for coupling to an Ethernet, token ring, or other type of network. In any event, in this manner, the computer system 300 may be coupled to a number of clients and/or other servers via a conventional network infrastructure, such as a company's Intranet and/or the Internet, for example.

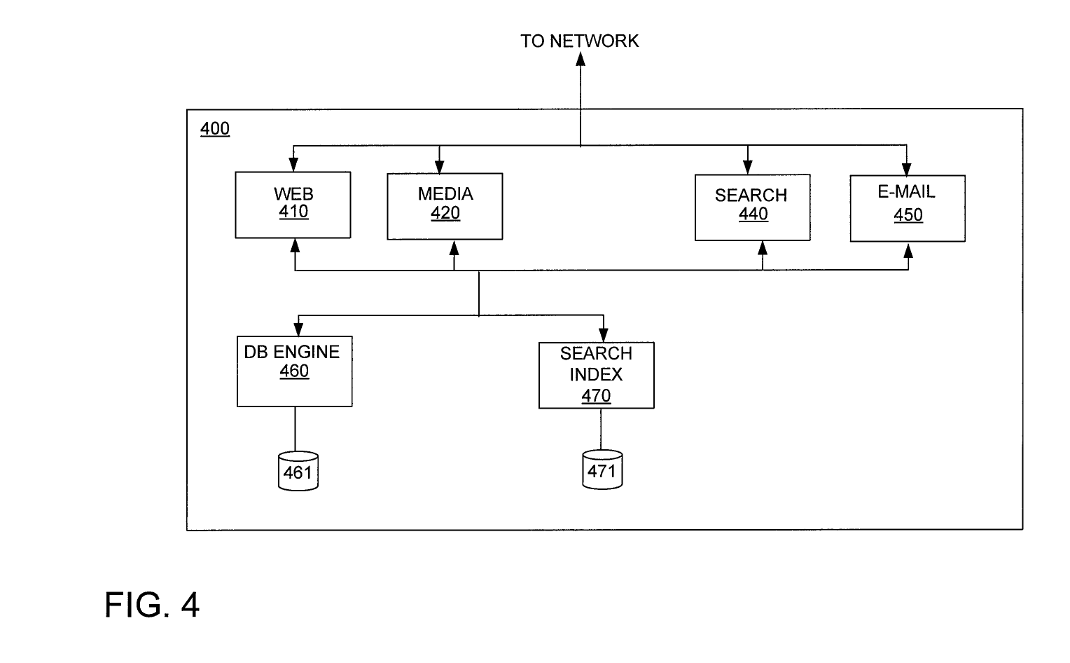

FIG. 4 is a block diagram illustrating one embodiment, among others, of an ISNS system 400. According to exemplary embodiments, the ISNS system 400 includes one or more of a number of types of front-end servers, namely Web servers 410 that deliver Web pages (e.g., markup language documents), media servers 420 that dynamically deliver images and other media to be displayed within Web pages and search servers 440 that handle search requests to the system 400. E-mail servers 450 provide automated e-mail communications to users of the system 400.

The back-end servers include a database engine server 460 and a search index server 470, each of which maintains and facilitates access to a respective database. Databases 461, 471 associated with the database engine server 460 and search index server 470, respectively, may include may include customer's information, such as business information, user codes and settings, payment information, etc. Generally, system servers and databases may maintain a collection of customer information and service order information. For example, plan parameters such as a percentage of calls to allocate to each alternate number may be maintained in databases 461, 471.

ISNS 400 may be accessed by a client program, such as a Web browser that executes on a client machine, such as the client machine 110, 160, 205, and accesses the system 400 via the network 230 such as, for example, the Internet. Other examples of networks that a client may utilize to access the system 400 include a wide area network (WAN), a local area network (LAN), a wireless network (e.g., a cellular network), or the Plain Old Telephone Service (POTS) network. The client machine 110, 205 may be a personal computer, mobile telephone, personal digital assistant (PDA). In fact, the client machine 110, 205 may be any device that can communicate with the system 400 via the network 230, and is capable of executing an appropriate client program.

Users may search databases 461, 471 for particular service order information or customer information that they are interested in reviewing or determining a status of a submitted service request. This is accomplished by software that is resident on the Web servers 410, which enable browsing and searching by customers of information stored on the database. Search functions may include partial key searches, as well as the ability to select or sort items based on Boolean search criteria, such as status identifier, service order numbers, service identifiers, dates, customer information, etc.

For security reasons, the ISNS 400 may be utilized in conjunction with a firewall or other security measure (not shown) to ensure confidentiality of sensitive information.

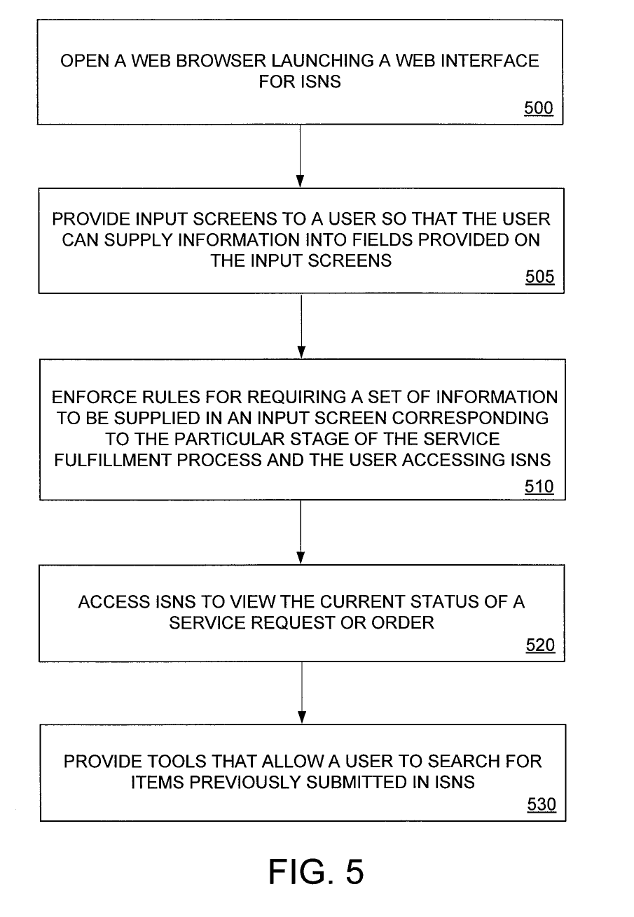

Referring now to FIG. 5, shown is a flow chart illustrating an embodiment, among others, of functionality of the service negotiation system 100 of FIG. 1. In step 500, the user selects to run the ISNS 400, and in response, the computer 110 will open a web browser launching a web interface for ISNS 400. It should also be recognized that ISNS 400 in some implementations includes password protection.

In step 505, ISNS 400 provides input screens to a user so that the user can supply information into fields provided on the input screens. The input screens correspond to a current stage of a service fulfillment process. For example, if a service consultant is creating a new service order, the service consultant is provided fields pertinent for establishing a requested service in an initial stage for fulfilling the service. In later stages, a technician, for example, may set up equipment needed to establish the service.

In step 510, rules are enforced by ISNS 400 for requiring a set of information to be supplied in an input screen corresponding to the particular stage of the service fulfillment process. If supplied information does not satisfy a rule then ISNS 400 does not submit the supplied information to server 210. After information is supplied, then designated persons may be notified of the submission of the information, where the designated persons are the next group responsible for performing actions as part of the service fulfillment process. Also, information associated with a particular service order may be viewed by authorized users who are not currently responsible for performing an action related to the service fulfillment process.

For example, a service consultant may submit an order and wait on a network technician to configure network hardware to implement the service that is the subject of the order. Accordingly, while the technician is performing his or her work, the service consultant can access ISNS 400 to view the current status of the service request or order, as represented in step 520. One skilled in the art should understand that the interfaces are typically tailored according to a service fulfillment process being implemented. For instance, if a service order process is directed towards satellite service, than it would have a different process requiring different interfaces to ISNS 400 than the CrisisLink service ordering process.

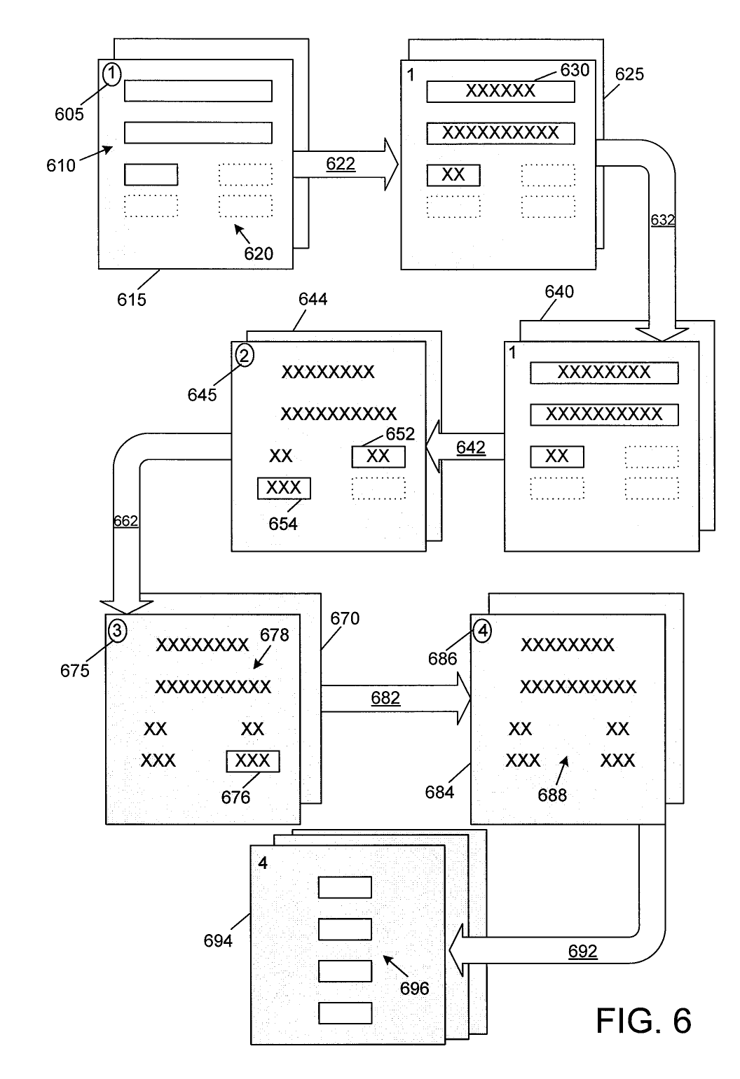

Referring now to FIG. 6, a diagram depicting an embodiment, among others, of a service fulfillment process is shown. In the diagram, ISNS interface screens or pages are generally depicted. For example, at a first stage 605 of a service fulfillment process, input boxes 610 are provided on one or more interface screens 615 so that a representative of a unit responsible for the first stage 605 can input information into the input boxes 610. On the same screen or on other screens that occur thereafter, input boxes 620 may also be provided that do not accept information from the representative of the unit for the first stage 605. In one embodiment, these input boxes 620 may be “grayed out.” The representative of the unit responsible for the first stage enters information (622) as represented by the X's in the next set of screens 625 shown in the diagram. In the first input box 630, the representative has entered 6 characters of text (which may include numerals and graphical symbols). In the present example, ISNS 400 enforces a rule that the input box 630 will only accept a string of characters that is 8 characters long.

Therefore, when the representative attempts to submit (632) the information provided in interface screens 625, ISNS 400 does not accept the information provided by the representative and re-presents the set of screens 625 to the user. Accordingly, in one embodiment, among others, ISNS 400 notifies the representative that the character string provided in input box 630 is in an incorrect format. When the representative provides the character string in the correct format, as represented by the next set of screens 640 shown in the diagram and submits (642) the information to be accepted by ISNS 400, ISNS 400 accepts the information and presents a set of interface screens 644 for a second stage 645 of the process.

In this stage 645, a representative for a unit responsible for this stage of the process reviews the information submitted previously. Further, ISNS 400 allows for the user of the unit responsible for the current stage 645 to fill out information in input boxes 652, 654 that were previously grayed out or prevented from being accessed. The representative of the unit responsible for the current stage 645 supplies the information intended for these input boxes and submits (662) the information to ISNS 400.

In the present example, the information provided is accepted by the ISNS 400, and ISNS 400 provides a set of interface screens 670 to a representative of a unit responsible for a third stage (675) of the service fulfillment process. Like the previous stage, an input box 676 previously blocked from access in prior stages is allowed to be accessed in the third stage 675. Therefore, the representative of the unit responsible for the third stage 675 can review previously submitted information 678, fill out the input box 676 with additional information, and submit (682) the newly added information to ISNS 400.

In the present example, ISNS 400 accepts the information and provides the next set of interface screens 684 for a fourth stage 686 of the service fulfillment process. Here, a representative of the unit responsible for the fourth stage 686 can review the previously provided information 688 and then request (692) additional interface screens or pages 694 (e.g., by clicking a NEXT link or button contained in one of the screens/pages). The additional interface screens 694 may include additional input boxes 696 so that the current representative can provide further information that is used to establish a service. Also, the current representative might be the same representative responsible for an earlier stage or be from a prior unit that was responsible for an earlier stage in the service fulfillment process. Likewise, the service fulfillment process might continue with additional stages. Also, it is noted that the foregoing examples are illustrative of one or more embodiments and are not meant to be limiting.

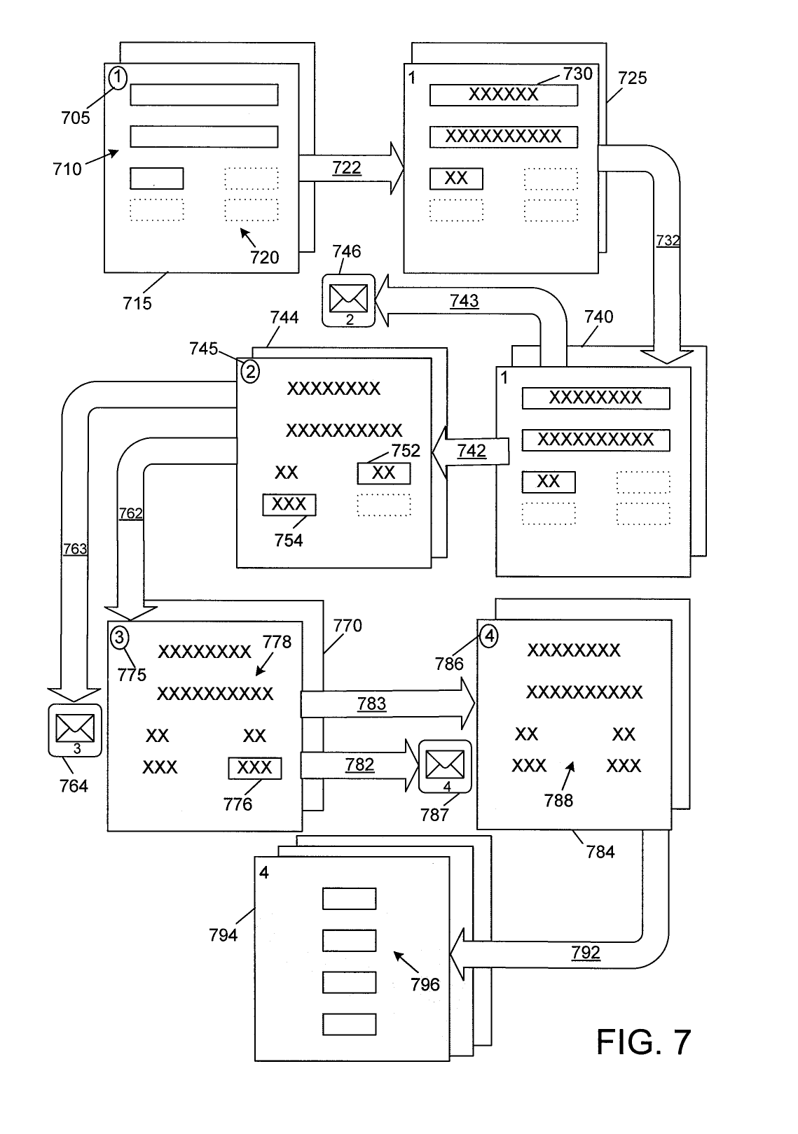

Referring now to FIG. 7, a diagram depicting an embodiment, among others, of service fulfillment process is shown. In the diagram, ISNS interface screens or pages are generally depicted. For example, at a first stage 705 of a service fulfillment process, input boxes 710 are provided on one or more interface screens 715 so that a representative of a unit responsible for the first stage 705 can input information into the input boxes 710. On the same screen or on other screens that occur thereafter, input boxes 720 may also be provided that do not accept information from the representative of the unit for the first stage 705. In one embodiment, these input boxes 720 may be grayed out. The representative of the unit responsible for the first stage 705 enters information (722) as represented by the X's in the next set of screens 725 shown in the diagram. In the first input box 730, the representative has entered 6 characters of text (which may include numerals and graphical symbols). In the present example, ISNS 400 enforces a rule that the input box 730 will only accept a string of characters that is 8 characters long.

Therefore, when the representative attempts to submit (732) the information provided in interface screens 725, ISNS 400 does not accept the information provided by the representative and re-presents the set of screens 725 to the user. In one embodiment, among others, ISNS 400 notifies the representative that the character string provided in input box 730 is in an incorrect format. Accordingly, when the representative provides the character string in the correct format, as represented by the next set of screens 740 shown in the diagram and submits (742) the information to be accepted by ISNS 400, ISNS accepts the information and presents a set of interface screens 744 for a second stage 745 of the process. In addition, an email 746 (or other form of communication) is caused to be sent (743) by ISNS 400 to a representative of the unit responsible for this stage of the service fulfillment process to notify the representative that the interface screens await the representative's review.

In this stage 745, the representative for a unit responsible for this stage of the process reviews the information submitted previously. Further, ISNS 400 allows for the user of the unit responsible for the current stage 745 to fill out information in input boxes 752, 754 that were previously grayed out or prevented from being accessed. The representative of the unit responsible for the current stage supplies the information intended for these input boxes and submits (762) the information to ISNS 400. In the present example, the information provided is accepted by the ISNS 400, and ISNS 400 provides a set of interface screens 770 to a representative of a unit responsible for a third stage (775) of the service fulfillment process. In addition, an email 764 is caused to be sent (763) by ISNS 400 to a representative of the unit responsible for this stage 775 of the service fulfillment process to notify the representative that the interface screens await the representative's review.

Like the previous stage, an input box 776 previously blocked from access by prior users of prior stages is allowed to be accessed in the third stage 775. Therefore, the representative of the unit responsible for the third stage 775 can review previously submitted information 778, fill out the input box 776 with additional information, and submit (783) the newly added information to ISNS 400. In addition, an email 787 (or other form of communication) is caused to be sent (782) by ISNS 400 to a representative of the unit responsible for this stage of the service fulfillment process to notify the representative that the interface screens await the representative's review.

Next, ISNS 400 provides the next set of interface screens 784 for a fourth stage 786 of the service fulfillment process. Here, a representative of the unit responsible for the fourth stage 786 can review the previously provided information 788 and then request (792) additional interface screens or pages 794 (e.g., by clicking a NEXT link or button located on a web interface page). The additional interface screens 794 may include additional input boxes 796 so that the current representative can provide further information that is used to establish a service. Also, the current representative might be the same representative responsible for an earlier stage or be from a prior unit that was responsible for an earlier stage in the service fulfillment process. Likewise, the service fulfillment process might continue with additional stages. It is noted that the foregoing examples are illustrative of one or more embodiments and are not meant to be limiting.

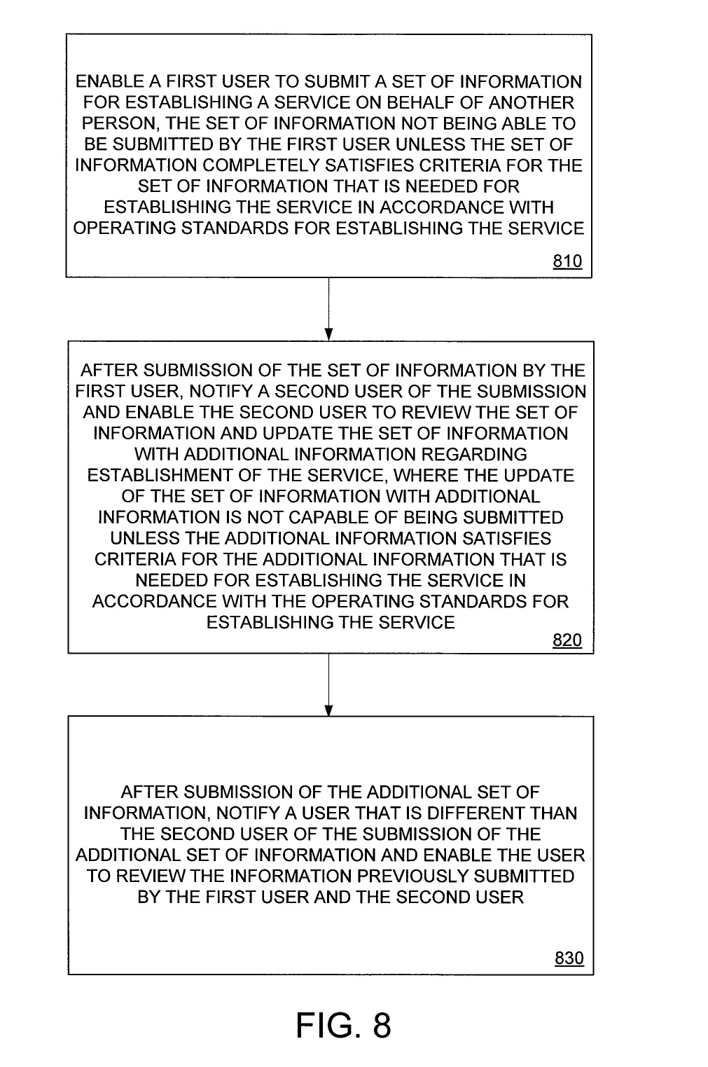

Referring now to the flow chart of FIG. 8, one embodiment, among others, of a process for negotiating a service, in accordance with the present disclosure is described. The process includes enabling (810) a first user to submit a set of information for establishing a service on behalf of another person (e.g., a customer, subscriber). According to exemplary embodiments, the set of information is not able to be submitted by the first user unless the set of information completely satisfies criteria for the set of information that is needed for establishing the service in accordance with operating standards for establishing the service, where the first user belongs to a first unit that is responsible for part of establishment of the service. In one or more embodiments, the information submitted by the first user is network-accessible by client machines 110, 160, 205 of other users.

The process further includes, after submission of the set of information by the first user, notifying (820) a second user of the submission and enabling the second user to review the set of information and update the set of information with additional information regarding establishment of the service.

The second user may belong to a second unit that is responsible for another part of establishment of the service, where the update of the set of information with additional information is not capable of being submitted unless the additional information satisfies criteria for the additional information that is needed for establishing the service in accordance with the operating standards for establishing the service.

Such a process further includes, after submission of the additional set of information, notifying (830) a user that is different than the second user of the submission of the additional set of information and enabling the user to review the information previously submitted by the first user and the second user.

In some embodiments, additional and aforementioned features and/or steps may also be provided. For example, in some embodiments, the user may belong to a third unit that is responsible for a different part of establishment of the service, where the different part is different from the part for which the first user is responsible and the another part for which the second user is responsible. As another example, the user may be a user belonging to the first unit, in some embodiments. Further, an embodiment, among others, of the process may include enabling the second user to mark that previously supplied information from the first user is incorrect and to provide comments regarding the supplied information which has been marked as incorrect which causes the first user to be automatically notified of the comments provided by the second user. Some embodiments may further include notifying a third user of the submission and enabling the third user to review the set of information and update the set of information with additional information regarding establishment of the service, where the third user belongs to a third unit that is responsible for another part of establishment of the service. Further, the update of the set of information with additional information may not be capable of being submitted unless the additional information satisfies criteria for the additional information that is needed for establishing the service in accordance with operating standards. Moreover, in some embodiments, the third user may be notified at the same time as the second user of new submissions of information. It is noted that the foregoing examples are illustrative of one or more embodiments and are not meant to be limiting.

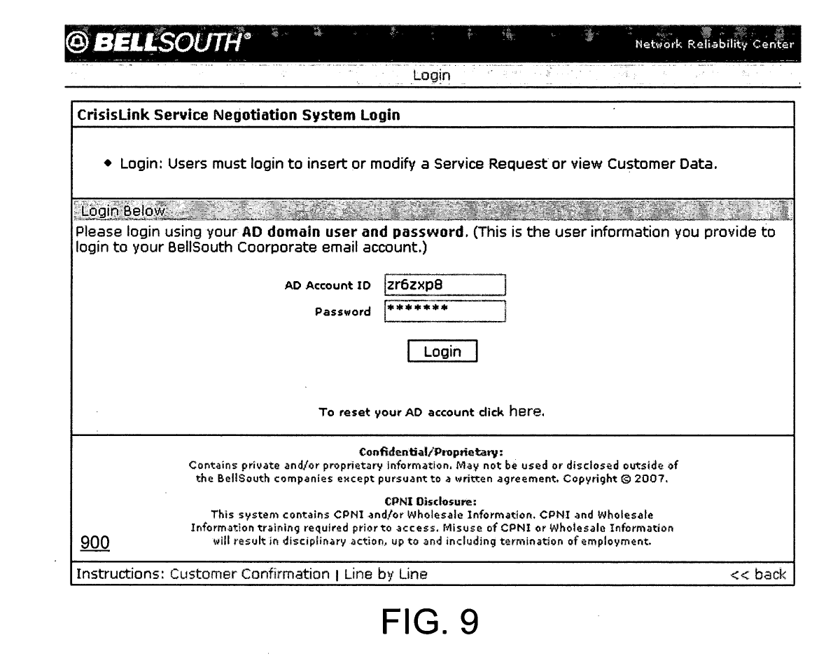

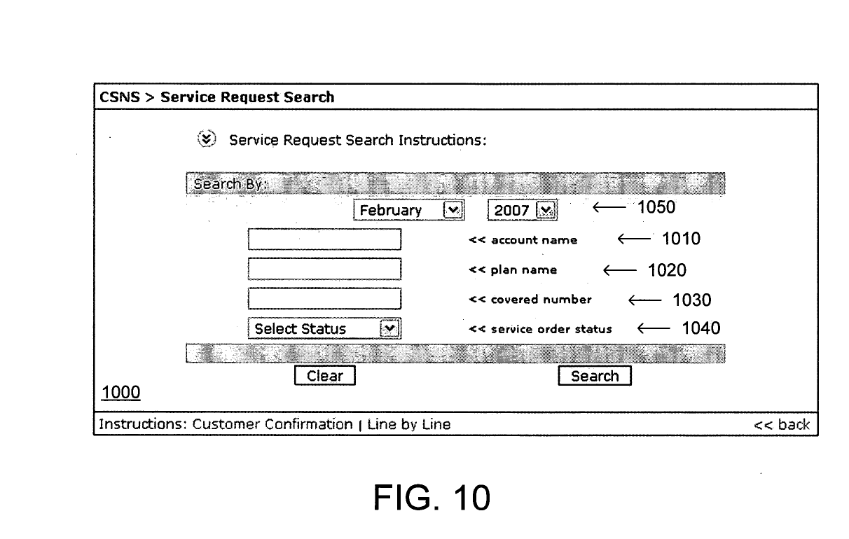

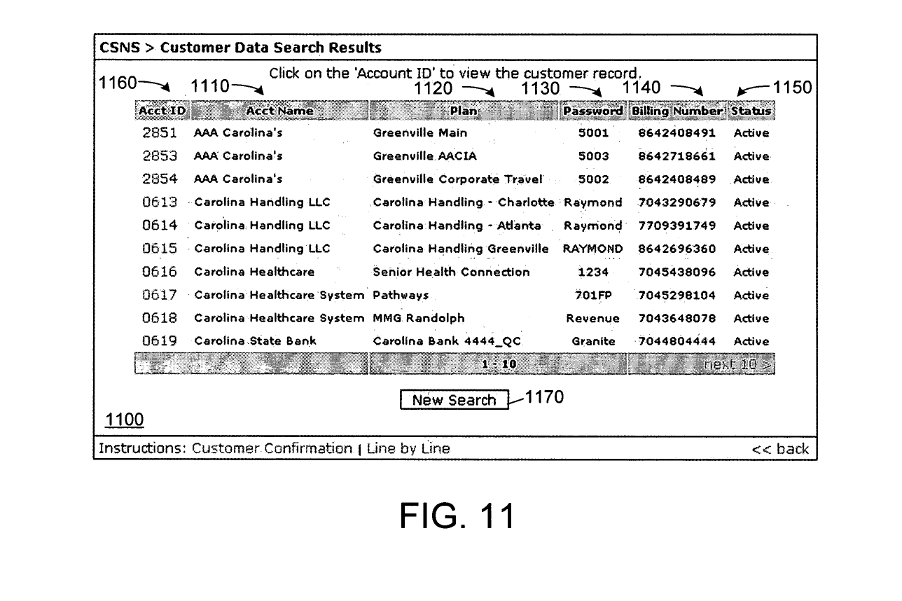

Screenshots of an exemplary ISNS interface, among others, are shown in FIGS. 9-14. In FIG. 9, a login screen 900 is shown where a user may login to insert or modify a service request or view customer data. After logging in, the user may be provided a service request search interface 1000, as shown in FIG. 10. Options are provided for searching by account name 1010, plan name 1020, covered number 1030, and service order status 1040, and date range 1050. For example, if the term “carolina” was inputted in the account name field 1010, then customer data search results 1100, such as that shown in FIG. 11, may be provided. It is noted that each of these search results has the term “carolina” in the account name 1110. Also shown in the results are the corresponding plan name 1120, password for accessing the plan 1130, billing number associated with the plan 1140, and status of the account 1150, and an account ID 1160. To perform a new search, a New Search button 1170 may be selected.

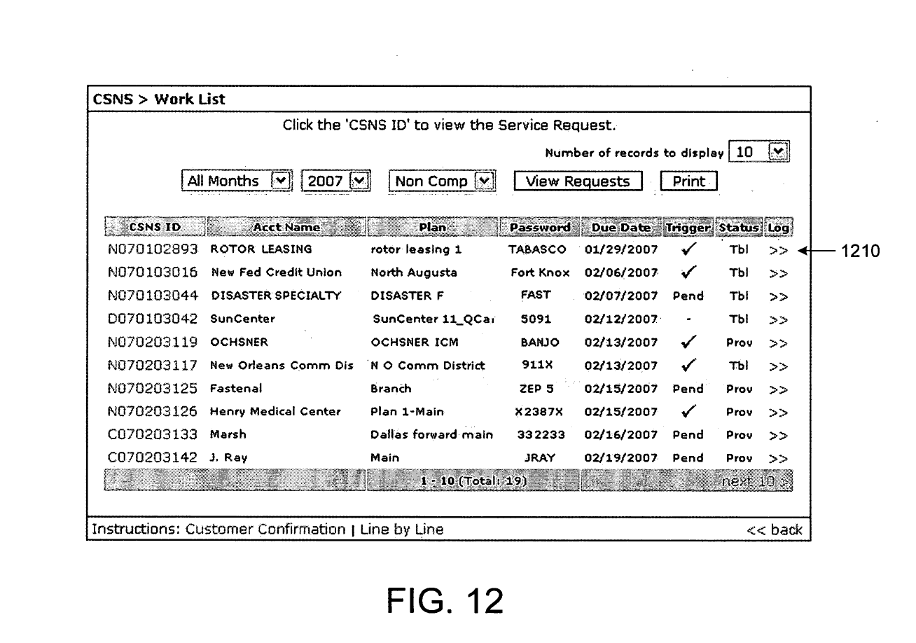

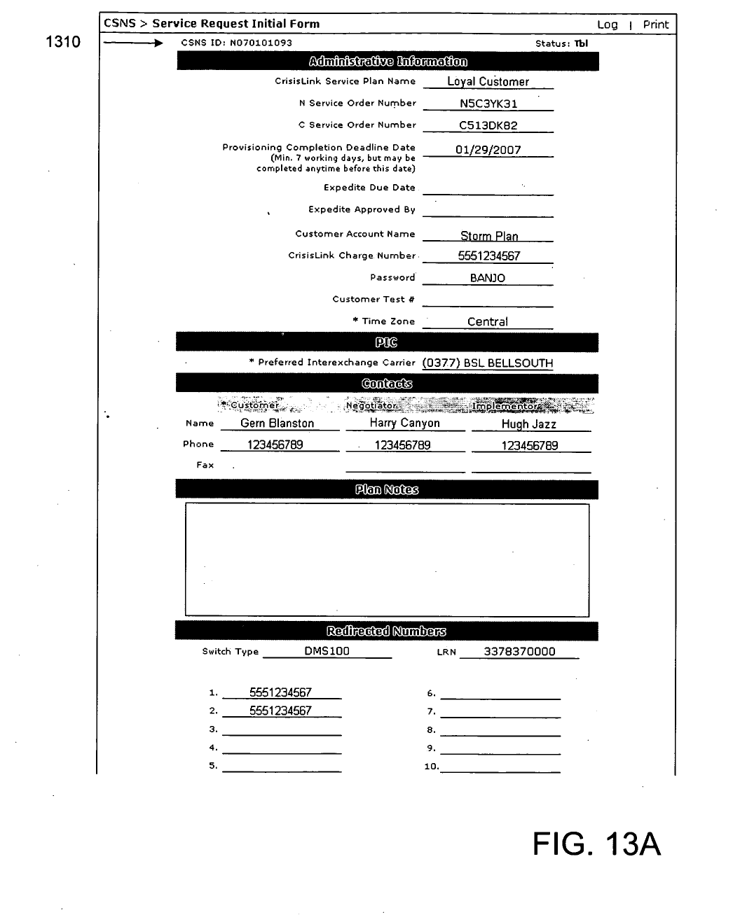

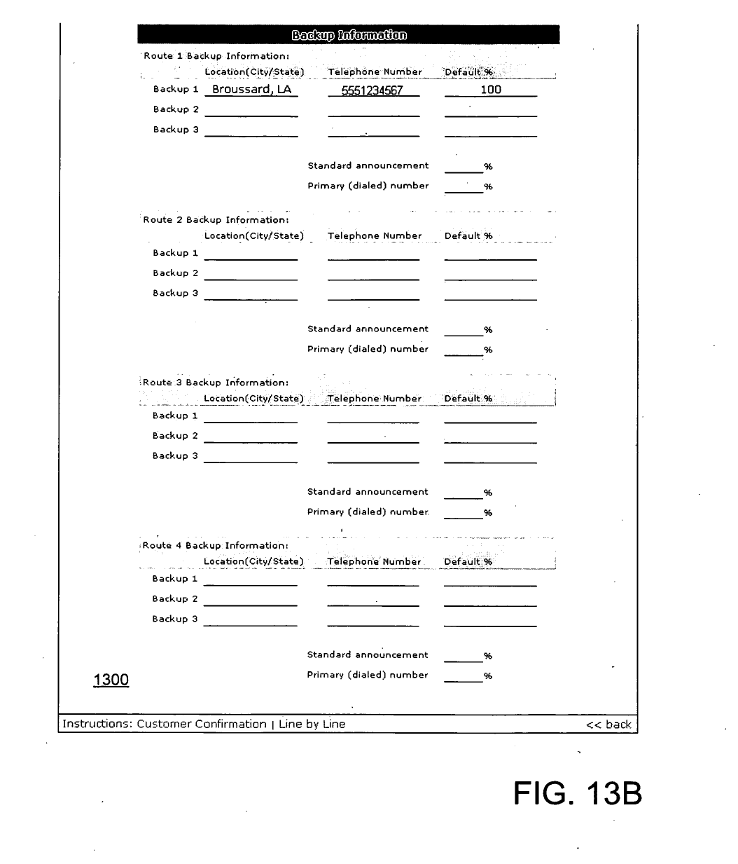

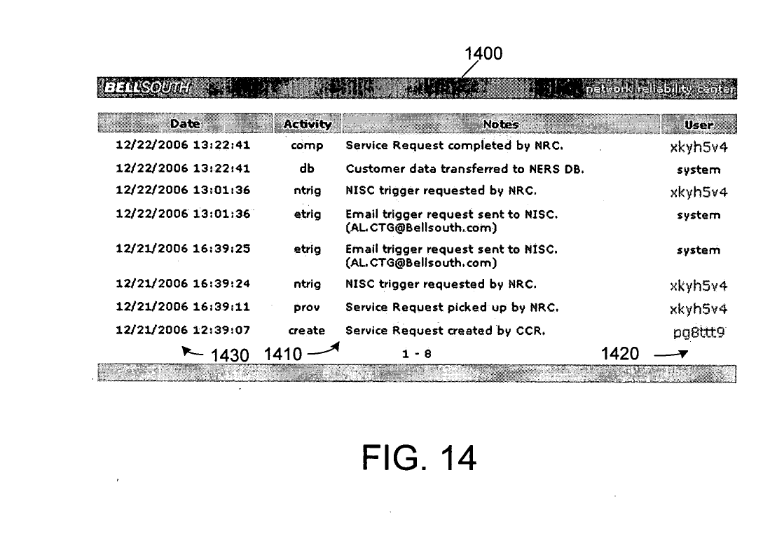

Another type of search that may be performed for a Work List of service requests, as shown in FIG. 12. In the example of FIG. 12, service requests having a due date for “All Months” of the year 2007 that are not completed (“Non Comp”) are displayed. To view a service request for one of the entries in the list, an individual CSNS ID may be selected, where the CSNS ID is an identifier for the service request in this example. FIG. 13 shows a screenshot of a service request that is displayed after selecting a N070101093 CSNS ID 1310 from a Work List (not shown). From the Work List, a log of activities may also be displayed by selecting the Log option 1210 for the desired service request. For example, FIG. 14 shows a log of the activities that have been performed for a service request from its creation on Dec. 21, 2006 to its completion on Dec. 22, 2006. The log 1400 shows what action has been performed 1410, by whom the action was performed 1420, and when the action has been performed for the service request 1430. Additional interface screens may also be provided. Of further note, the present examples are illustrative and not meant to be limiting.

Any process descriptions or blocks in flow charts should be understood as representing modules, segments, or portions of code which include one or more executable instructions for implementing specific logical functions or steps in the process, and alternate implementations are included within the scope of some embodiments of the present disclosure in which functions may be executed out of order from that shown or discussed, including substantially concurrently or in reverse order, depending on the functionality involved, as would be understood by those reasonably skilled in the art of the present disclosure.

Components of embodiments of the present disclosure can be implemented in hardware, software, firmware, or a combination thereof. In one embodiment, various components are implemented in software or firmware that is stored in a memory and that is executed by a suitable instruction execution system. If implemented in hardware, as in an alternative embodiment, the components can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Software components, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. Specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). The scope of the present disclosure includes embodying the functionality of some embodiments in logic embodied in hardware or software-configured mediums.

Conditional language, such as, among others, “can,” “could,” “might,” or “may,” unless specifically stated otherwise, or otherwise understood within the context as used, is generally intended to convey that certain embodiments could include, but do not require, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure.

Therefore, having thus described the invention, at least the following is claimed:

1. A method for negotiating a service, comprising:
enabling a first user to submit a set of information for establishing a service on behalf of another person, the set of information prohibited from being submitted by the first user unless the set of information completely satisfies criteria for the set of information that is needed for establishing the service in accordance with operating standards for establishing the service, the first user belonging to a first unit that is responsible for part of establishment of the service;
after submission of the set of information by the first user, notifying a second user of the submission and enabling the second user to review the set of information and update the set of information with additional information regarding the establishment of the service, the second user belonging to a second unit that is responsible for another part of the establishment of the service, wherein the update of the set of information with additional information is prohibited from being submitted unless the additional information satisfies criteria for the additional information that is needed for establishing the service in accordance with the operating standards for establishing the service; and
after submission of the additional set of information, notifying a user that is different than the second user of the submission of the additional set of information and enabling the user to review the information previously submitted by the first user and the second user.

2. The method of claim 1, wherein the user belongs to a third unit that is responsible for a different part of establishment of the service, the different part being different from the part for which the first user is responsible and the another part for which the second user is responsible.

3. The method of claim 1, wherein the user comprises a user belonging to the first unit.

4. The method of claim 1, further comprising:
enabling the second user to mark that previously supplied information from the first user is incorrect and to provide comments regarding the supplied information which has been marked as incorrect which causes the first user to be automatically notified of the comments provided by the second user.

5. The method of claim 2, further comprising:
notifying a third user of the submission and enabling the third user to review the set of information and update the set of information with additional information regarding establishment of the service, the third user belonging to a third unit that is responsible for another part of establishment of the service, wherein the update of the set of information with additional information is prohibited from being submitted unless the additional information satisfies criteria for the additional information that is needed for establishing the service in accordance with the operating standards for establishing the service, wherein the third user is notified at the same time as the second user.

6. The method of claim 1, wherein the service comprises a telephone forwarding service to at least one back-up telephone number used when a telephone service is disabled for a first telephone number.

7. The method of claim 1, further comprising:
providing a web-based forum for supplying information regarding the service that is stored in at least one database and is able to be accessed by at least one other user.

8. A computer readable medium having a computer program for negotiating a service, the program comprising:
enabling a first user to submit a set of information for establishing a service on behalf of another person, the set of information prohibited from being submitted by the first user unless the set of information completely satisfies criteria for the set of information that is needed for establishing the service in accordance with operating standards for establishing the service, the first user belonging to a first unit that is responsible for part of establishment of the service;
after submission of the set of information by the first user, notifying a second user of the submission and enabling the second user to review the set of information and update the set of information with additional information regarding the establishment of the service, the second user belonging to a second unit that is responsible for another part of the establishment of the service, wherein the update of the set of information with additional information is prohibited from being submitted unless the additional information satisfies criteria for the additional information that is needed for establishing the service in accordance with the operating standards for establishing the service; and
after submission of the additional set of information, notifying a user that is different than the second user of the submission of the additional set of information and enabling the user to review the information previously submitted by the first user and the second user.

9. The computer readable medium of claim 8, wherein the user belongs to a third unit that is responsible for a different part of establishment of the service, the different part being different from the part for which the first user is responsible and the another part for which the second user is responsible.

10. The computer readable medium of claim 8, wherein the user comprises a user belonging to the first unit.

11. The computer readable medium of claim 8, further comprising:
enabling the second user to mark that previously supplied information from the first user is incorrect and to provide comments regarding the supplied information which has been marked as incorrect which causes the first user to be automatically notified of the comments provided by the second user.

12. The computer readable medium of claim 9, further comprising:
notifying a third user of the submission and enabling the third user to review the set of information and update the set of information with additional information regarding establishment of the service, the third user belonging to a third unit that is responsible for another part of establishment of the service, wherein the update of the set of information with additional information is prohibited from being submitted unless the additional information satisfies criteria for the additional information that is needed for establishing the service in accordance with the operating standards for establishing the service, wherein the third user is notified at the same time as the second user.

13. The computer readable medium of claim 8, wherein the service comprises a telephone forwarding service to at least one back-up telephone number used when a telephone service is disabled for a first telephone number.

14. The computer readable medium of claim 8, the program further comprising:
providing a web-based forum for supplying information regarding the service that is stored in at least one database and is able to accessed by at least one other user.

15. A system for negotiating a service comprising:
a web server system facilitating a web-based forum enabling a first user to submit a set of information for establishing a service on behalf of another person, the set of information prohibited from being submitted by the first user unless the set of information completely satisfies criteria for the set of information that is needed for establishing the service in accordance with operating standards for establishing the service enforced by the web server system, the first user belonging to a first unit that is responsible for part of establishment of the service;
after submission of the set of information by the first user, the web server system is configured to notify a second user of the submission and enable the second user to review the set of information and update the set of information with additional information regarding the establishment of the service, the second user belonging to a second unit that is responsible for another part of the establishment of the service, wherein the update of the set of information with additional information is prohibited from being submitted to the web server system unless the additional information satisfies criteria for the additional information that is needed for establishing the service in accordance with the operating standards enforced by the web server system; and
after submission of the additional set of information, the web server system is further configured to notify a user that is different than the second user of the submission of the additional set of information and enable the user to review the information previously submitted by the first user and the second user.

16. The system of claim 15, further comprising:
an e-mail server configured to receive commands from the web server system and in response to the commands, send notification messages to the first user and the second user.

17. The system of claim 15, wherein the user belongs to a third unit that is responsible for a different part of establishment of the service, the different part being different from the part for which the first user is responsible and the another part for which the second user is responsible.

18. The system of claim 15, wherein the web server system is further configured to enable the second user to mark that previously supplied information from the first user is incorrect and to provide comments regarding the supplied information which has been marked as incorrect which causes the first user to be automatically notified of the comments provided by the second user.

19. The system of claim 15, wherein the web server system is further configured to notify a third user of the submission and enabling the third user to review the set of information and update the set of information with additional information regarding establishment of the service, the third user belonging to a third unit that is responsible for another part of establishment of the service, wherein the update of the set of information with additional information is prohibited from being submitted to the web server system unless the additional information satisfies criteria for the additional information that is needed for establishing the service in accordance with the operating standards enforced by the web server system, wherein the third user is notified at the same time as the second user.

20. The system of claim 15, wherein the user comprises a user belonging to the first unit.
